(19) United States
(12) Patent Application Publication
(10) Pub. No.: US 2018/0315002 A1
(43) Pub. Date: Nov. 1, 2018

(54) COORDINATED DELIVERY OF ITEMS

(71) Applicant: Amazon Technologies, Inc., Seattle, WA (US)

(72) Inventors: Cary Rotman, Seattle, WA (US); Ramsin Betyousef, Seattle, WA (US); Steven Armato, Seattle, WA (US)

(21) Appl. No.: 14/970,172

(22) Filed: Dec. 15, 2015

(51) Int. Cl. G06Q 10/08; G06Q 30/06

(52) U.S. Cl. CPC G06Q 10/083; G06Q 30/0635

(57) ABSTRACT

Systems and methods are described for provision of coordinated-delivery offers (“CDOs”) using a coordinated delivery determination system (“CDDS”). The CDDS may be configured to receive an indication of multiple items which are to be shipped to a destination. The CDDS may provision an offer for coordinated delivery of these items to the destination within a pre-determined window of time. The CDDS may be configured to determine feasibility of a CDO. The CDDS may be configured to determine whether the delivery promise date is feasible based on a delivery threshold. The CDDS may also be configured to determine whether the CDO is feasible based on a pre-determined cost.

### BACKGROUND

As online customers become more savvy, they may begin to expect more particularized shopping experiences. In particular, customers may prefer to have increased options for how they are to receive their packages. Current techniques provide for customers to receive packages sent via particular shipping methods and/or according to particular schedules. However, customers have very limited choices or influences over the shipping methods and/or schedules.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a diagram illustrating an example of a coordinated delivery determination system providing a coordinated delivery offer, in accordance with various embodiments.

FIG. 2 is a block diagram illustrating example logical components and interaction points of the coordinated delivery determination system, in accordance with various embodiments.

FIG. 3 is a flowchart illustrating an example process for facilitating coordinated delivery of items, in accordance with various embodiments.

FIG. 4 is a flowchart illustrating an example process for determining whether a user is likely to desire a coordinated delivery offer.

FIG. 5 is a flowchart illustrating an example process for determining a potential coordinated delivery offer date/time, in accordance with various embodiments.

FIG. 6 is a flowchart illustrating an example process for determining feasibility of a potential coordinated delivery offer date, in accordance with various embodiments.

FIG. 7 illustrates an example computing environment in which embodiments described in the present disclosure may be implemented in accordance with various embodiments.

### DETAILED DESCRIPTION

Techniques are described for provision of coordinated delivery offers (“CDOs”) using a coordinated delivery determination system (“CDDS”). In various embodiments, the CDDS may be configured to receive an indication of a plurality of items which are to be shipped to a destination. The CDDS may be configured to provision a CDO for coordinated delivery of these items to the destination. In various embodiments, the CDO may include an offer to deliver two or more of the items such that they arrive at the destination within a pre-determined window of time of each other. In various embodiments, the offer may be provided to a customer that has ordered the items. In various embodiments, by providing a CDO, the CDDS may provide a superior experience for a customer, or other person receiving the items, such that a smaller delivery time window may be used and the customer will receive their items contemporaneously (or close to contemporaneously).

In various embodiments, the CDO may offer delivery of the items within various pre-determined windows. For example, the CDO may offer delivery of the items simultaneously, or within a few hours of each other, or within a few days of each other. In various embodiments, the CDDS may be configured to determine whether the multiple items may be delivered within a delivery window, and, if so, determine one or more delivery promise dates by which the requested items may be delivered within such a window. In various embodiments, the CDO may offer delivery of the items combined into fewer packages, or in individual or separate packages. In various embodiments, the CDDS may be configured to determine the delivery date based at least in part on information maintained in a plurality of databases, such as, but not limited to: customer preferences, item information such as item type, destination information, fulfillment center information, and shipping information.

In other embodiments, the CDDS may be configured to determine feasibility of a CDO. In various embodiments, feasibility determination may be performed based on various metrics, including, but not limited to, shipment cost, delivery date, price, and/or item type. This feasibility determination may be performed, for example, because an offer for coordinated delivery may include a delivery promise date that is later than a non-coordinated delivery. In another example, the feasibility may be performed because a CDO may include a delivery cost that is higher than that for a traditional shipment. In other embodiments, the feasibility may be performed because particular items, including, but not limited to, fragile items, luxury items, or items with limited availability, may be impossible or undesirable to deliver in coordination with other items. In various embodiments, the CDDS may be configured to determine whether the CDO is feasible based on a delivery threshold. This delivery threshold may be based, in whole or in part, on a possible delivery date for a non-coordinated delivery for the multiple items. Similarly, in various embodiments, the CDDS may be configured to determine whether the CDO is feasible based on a cost threshold, which may be based, in whole or in part, on a possible delivery cost for a non-coordinated delivery shipment.

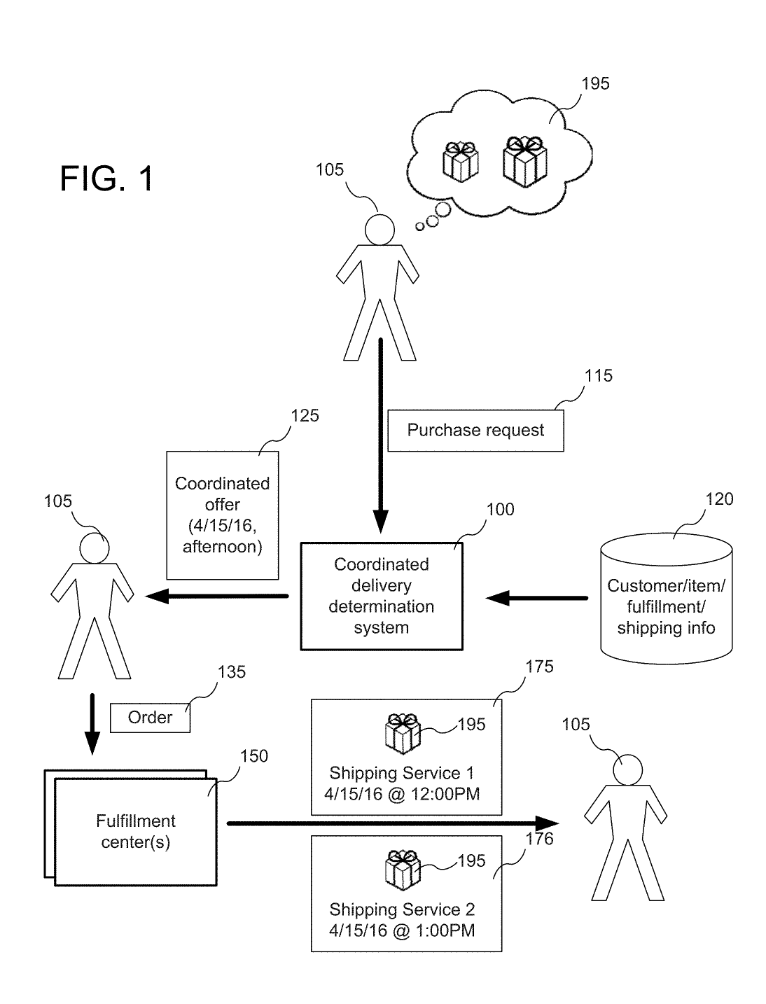

Referring now to FIG. 1, a diagram illustrating an example of a coordinated delivery determination system 100 (“CDDS 100”) providing a coordinated delivery offer 125 (“CDO 125”) is illustrated in accordance with various embodiments. In the example of FIG. 1, a customer 105 may desire to purchase a plurality of items 195. The customer may provide a purchase request 115 to the CDDS 100. In various embodiments, this purchase request may be provided through various techniques such as, for example, the use of an online or telephone-based retail system. In various embodiments, the CDDS 100 may provide a CDO 125 to the customer 105. In the particular example of FIG. 1, the CDO 125 may be for a coordinated delivery where items 195 may be delivered in the afternoon on a particular date. However, in other embodiments, the CDO 125 may be for simultaneous delivery of the items 195 (such as in a single package or in multiple packages using a single shipper) or for delivery of items 195 over the course of one or more days. In yet other embodiments, the CDO 125 may be for an ordered delivery within a particular window of time, where one item may be offered to be delivered prior to another item within the window. In various embodiments, provision of such an ordered delivery offer could be based on item type or other factors. For example, if customer 105 were to be holding an event and request a purchase of both decorations and food, in various embodiments, the customer 105 may be offered a CDO 125 that coordinates delivery so that the purchased decorations may arrive before (e.g., one day before) the purchased food.

In various embodiments, the CDDS 100 may provide the CDO 125 based on information provided from one or more databases, as represented by customer/item/fulfillment/shipping information storage 120. Particular examples of information provided for the provisioning of CDOs are discussed below. After provision of the CDO 125, the customer 105 may place an order 135 for the items 195, thus accepting the CDO 125. After placement of the order 135, one or more fulfillment centers 150 (“FCs 150”) may ship the items 195 in packages 175 and 176. In the example of FIG. 1, the CDO 125 was for coordinated delivery of both items in a single afternoon. Thus, in the example, package 175 was delivered at noon on Apr. 15, 2016 using shipping service 1, while package 176 was delivered at 1:00 PM on the same day using shipping service 2. As such, the items 195 are delivered to the customer 105 on the same day in the afternoon, per the CDO 125. The customer 105 may thus receive the items 195 relatively contemporaneously, reducing the window during which the customer 105 may have to wait for delivery of the multiple items 195. It may be noted, however, that while a single-day CDO 125 and two shipments 175 and 176 for separate same-day delivery are illustrated in FIG. 1, in various embodiments, the CDO 125 may offer delivery of the items 195 simultaneously or over multiple days using one or more shipping services.

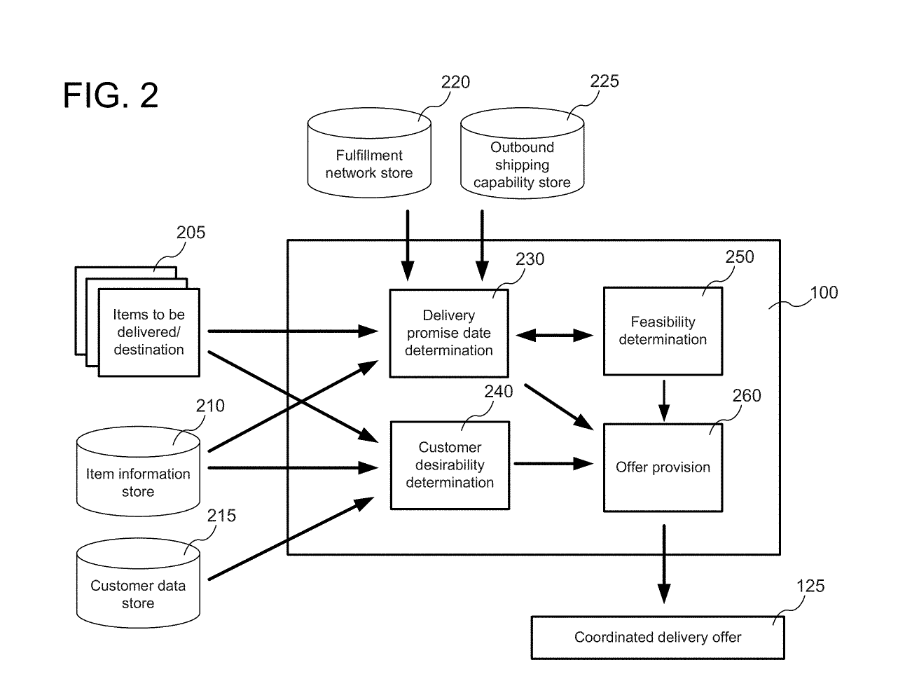

Referring now to FIG. 2, example logical components and interaction points of the CDDS 100 are illustrated in accordance with various embodiments. In various embodiments, the CDDS 100 may include one or more modules which may be configured to perform various techniques described herein. In various embodiments, these modules may be configured to operate in a computing environment, such as described herein. The CDDS 100 may also be configured to interoperate with one or more data stores, which may maintain information that may be used by one or more modules of the CDDS 100 to perform techniques described herein. In various embodiments, data stores may be implemented in various manners which may be understood by those of ordinary skill, including single-device, multiple-device, and distributed forms. It may be noted that, while particular modules, data stores, and/or information flows are illustrated in FIG. 2, in various embodiments, the CDDS 100 may be configured with more or fewer modules, interactions with different combinations of one or more data stores, and may utilize different information flows.

In various embodiments, the CDDS 100 may include a delivery promise date determination module 230 (“DPD 230”). The DPD 230 may be configured, in various embodiments, to receive indications 205 of multiple items 195, such as from a customer 105. These indications 205 may include item-identifying information as well as a destination to which the items are desired to be delivered. The DPD 230 may, in turn, determine one or more delivery promise dates to be used for a CDO 125 for the items 195. In various embodiments, the DPD 230 may determine one or more coordinated delivery options for the items 195. The DPD 230 may determine the one or more delivery promise dates through a determination of whether the items are currently available to be shipped from a single FC 150, whether the items can be moved to a single FC 150 for later shipment, or whether the items can be shipped from multiple FCs 150. Such determinations may be followed by a determination of shipping options from the one or more particular FCs 150. In various embodiments, the DPD 230 may interoperate with one or more databases or data stores, such as a fulfillment network data store 220 (“FNS 220”) and/or an outbound shipping capability data store 225 (“OS S 225”). The FNS 220 may be configured, in various embodiments, to store information about the location(s) of one or more of the items 195 in one or more FCs 150. The OSS 225 may be configured, in various embodiments, to store information about outbound shipping capabilities, including capabilities of one or more shipping providers, pick-up times, delivery routes, transit times, shipping costs, etc. In other embodiments, the OSS 225 may be configured with information usable to provide explicit shipping instructions to one or more shipping providers, such as to facilitate delivery of items on specific days or at specific times. In various embodiments, the DPD 230 may also determine a coordinated delivery window in which coordinated delivery may be provided. For example, the DPD 230 may determine that, for a particular combination of items 195, the items 195 should be delivered on the same day or even simultaneously. In other embodiments, the DPD 230 may determine that the items 195 should be delivered within a few days of each other.

In various embodiments, the DPD 230 may determine costs for one or more determined coordinated delivery options. Particular implementation of operations of the DPD 230 are described herein. In various embodiments, “fulfillment” may include various techniques for providing items for shipping or delivery to a customer, including, but not limited to, trans-shipping between FCs, packaging for shipment to a residential or commercial address, delivery to a pick-up location, fulfillment by one or more services other than a service through which a customer ordered items, etc.

The CDDS 100 may also include a customer desirability determination module 240 (“CDD 240”). In various embodiments, the CDD 240 may be configured to receive the indications 205 of the items and, in turn, determine whether the customer 105 is likely to desire coordinated delivery of the items 195. In various embodiments, the CDD 240 may utilize information about the items 195, which may be stored in an item information data store 210. The item information data store 210 may include information about items that may be utilized by the CDD 240, which may include information such as, but not limited to, item type, associations between items (such as items that are to be used together), time sensitivity of items, etc. In various embodiments, the CDD 240 may also utilize customer information, which may be stored in a customer data store 215. The customer data store 215 may include information such as, but not limited to, customer preferences, customer demographics, customer order history, etc.

In various embodiments, the CDDS 100 may also include a feasibility determination module 250 (“FD 250”) which may be configured to determine the feasibility of CDOs 125. In various embodiments, the FD 250 may receive one or more delivery promise dates for the items from the DPD 230. The FD 250 may also receive one or more shipping costs from the DPD 230. In various embodiments, the FD 250 may compare the delivery promise dates to a delivery threshold. In various embodiments, the FD 250 may also compare costs and/or shipment prices to a cost threshold. In other embodiments, the FD 250 may perform other feasibility determinations, such as by comparing shipping weight to a weight threshold. In various embodiments, through comparison of the determined delivery promise date and/or costs, the FD 250 may determine whether a determined delivery promise date/cost is feasible to use in a CDO 125.

In various embodiments, an offer provision module 260 (“OP 260”) may be configured to take the determinations of feasibility and the information about the one or more delivery promise dates, and select from available coordinated-delivery options to provide one or more CDOs 125 to a user, such as a customer 105. In various embodiments, the OP 260 may be configured to generate a price for a particular coordinated delivery option. The OP 260 may be configured to generate the price based on, for example, the cost of the one or more shipping options utilized in a coordinated delivery option and/or added convenience to a recipient of the items whose delivery is coordinated. Examples of such provision may include telephone, print, and/or online retail provision of a CDO 125. In various embodiments, the OP 260 may provide one or more CDOs 125. In various embodiments, the selected CDOs 125 may be selected to provide a range of options for a customer 105, such as price and/or delivery time options, and/or delivery windows of different sizes. In various embodiments, the CDOs 125 provided to the customer by the OP 260 may each include one or more of, but are not limited to: shipping cost, delivery promise date(s), shipping provider(s), shipping class(es), etc. Various techniques for providing offers may be known to those of ordinary skill.

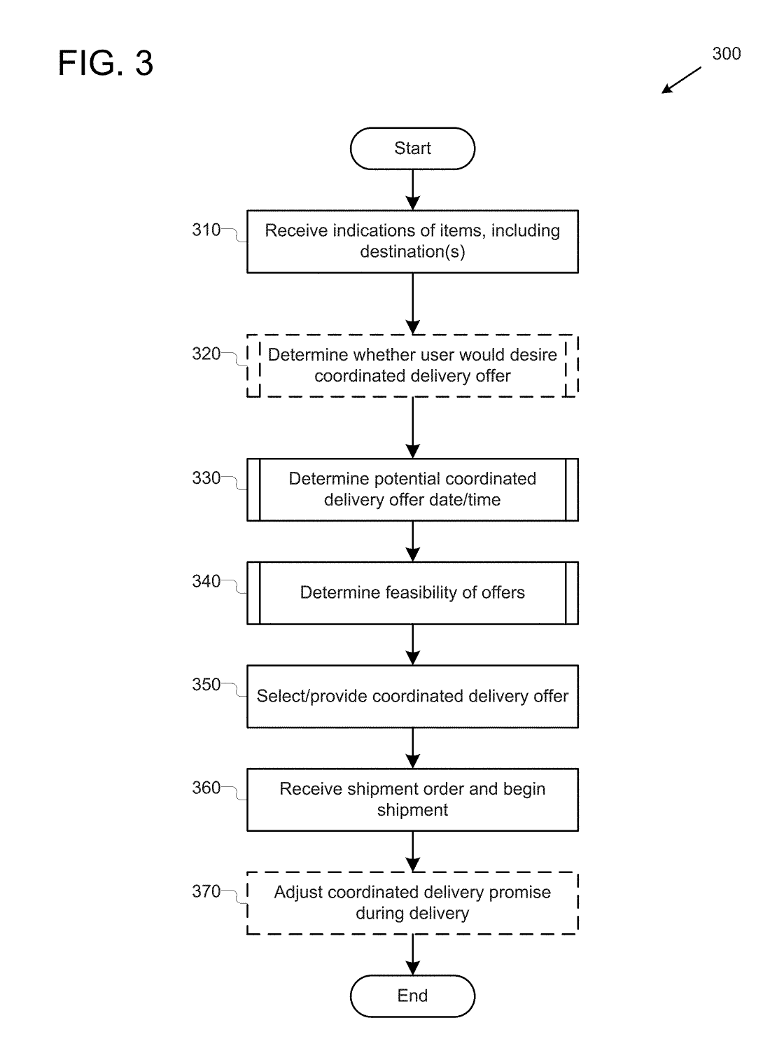

Referring now to FIG. 3, a flowchart illustrating an example process 300 for facilitating coordinated delivery of items is illustrated in accordance with various embodiments. While particular examples and orders of operations are illustrated in FIG. 3, in various embodiments, these operations may be re-ordered, broken into additional operations, combined, and/or omitted altogether. The process may begin at operation 310, where the CDDS 100 may receive indications of a plurality of items 195 to be shipped. In various embodiments, the plurality of items 195 may include items which a customer 105 has requested to purchase, such as on an online or telephone-based retail service. Additionally, at operation 310, the CDDS may receive a destination, such as an address, for the shipment of the items 195. In various embodiments, the CDDS 100 may receive a shipping destination that includes multiple addresses. For example, if a coordinated mail service, such as a mail room at an office building or a university dormitory, provides services for multiple postal addresses, the CDDS 100 may still recognize these addresses as going to the same destination for the purposes of creating a CDO 125. In such a scenario, the CDO 125 may be provided for the convenience of the coordinated mail service rather than, or in addition to, the convenience of the customer. In various embodiments, the destination received at operation 310 may also match one or more destinations received from other customers. The CDDS 100 may, by providing coordinated delivery across multiple customers, similarly benefit coordinated mail services. In various embodiments, the indications of items and their destination may be received as part of a shipment or purchase request for the items, such as from a retail service.

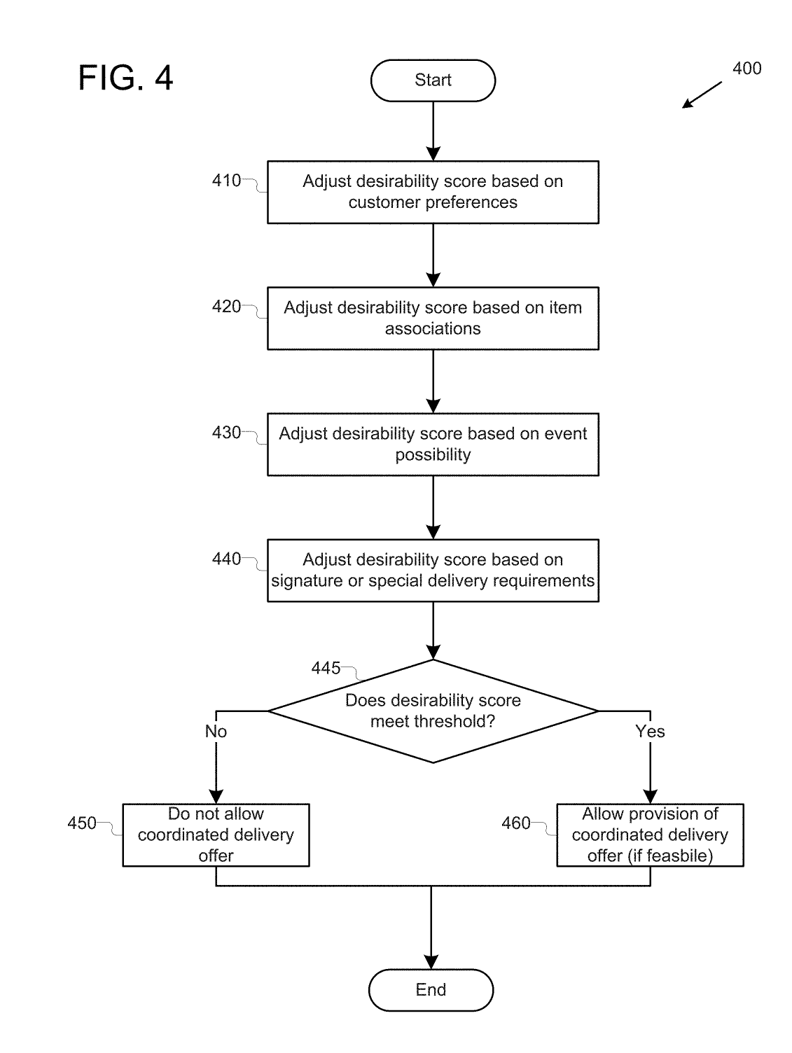

Next, at operation 320, the CDD 240 may optionally determine whether the customer 105 is likely to desire to receive a CDO 125. In various embodiments, the CDD 240 may consider various pieces of customer and/or item information when determining whether it is likely that the customer 105 may desire to receive a CDO 125. In various embodiments, such customer and/or item information may include, but is not limited to, information such as customer preferences, customer location, item type, item associations, customer events, etc. Particular examples of operation 320 are described below with reference to process 400 of FIG. 4.

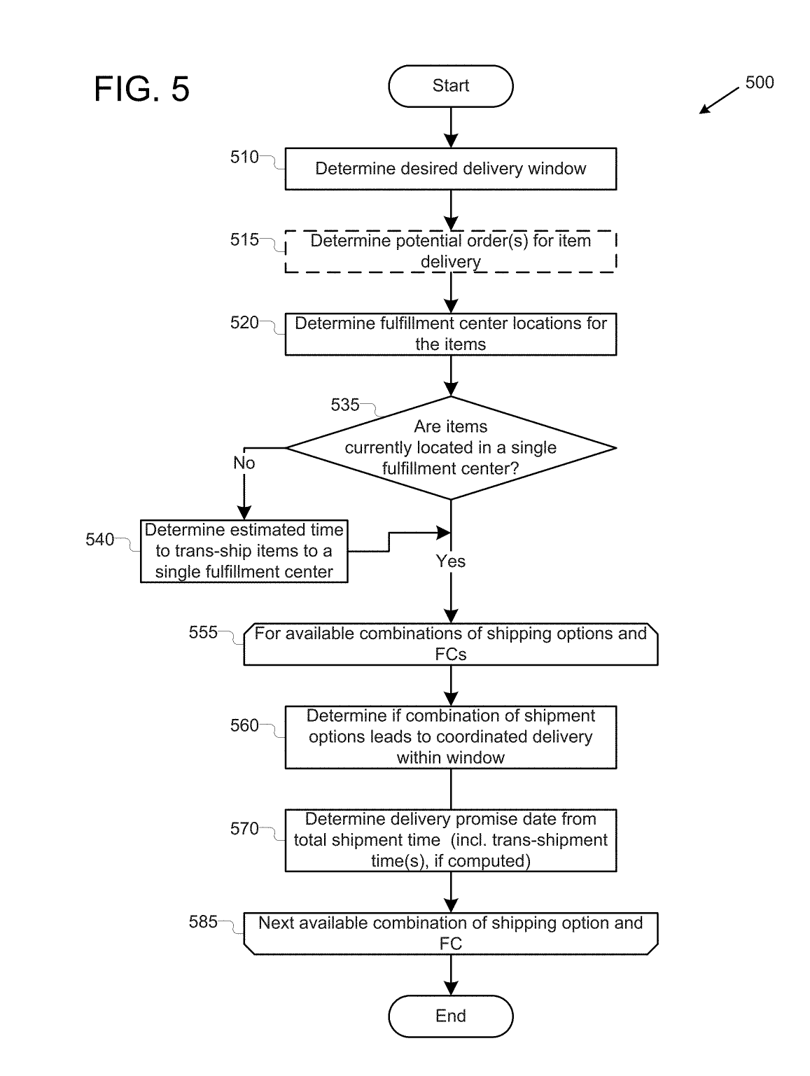

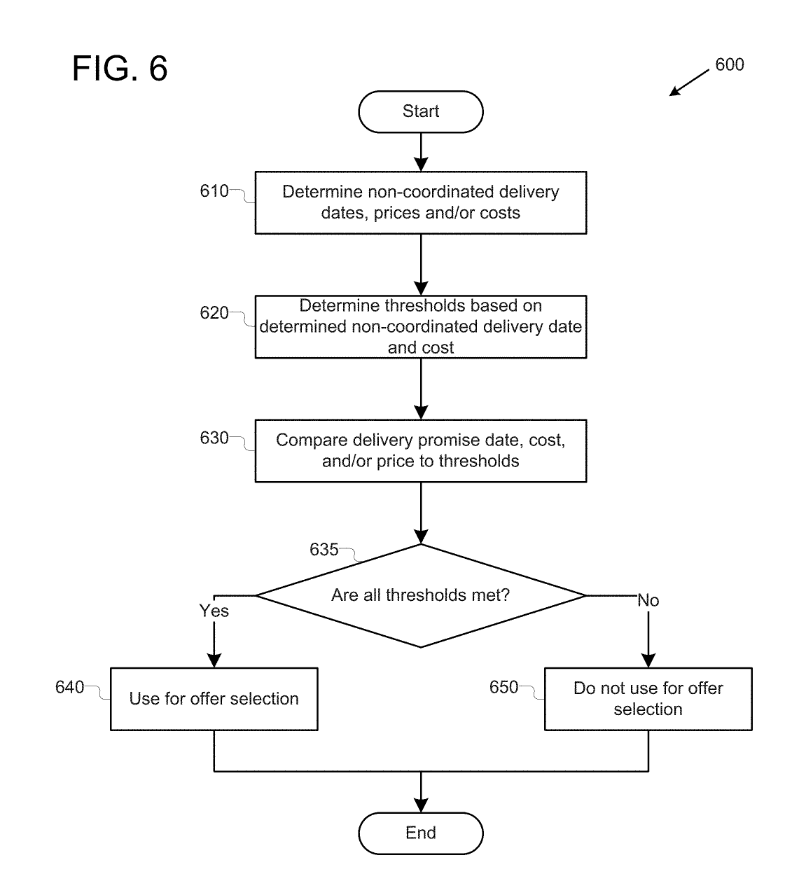

At operation 330, the DPD 230 may determine one or more potential coordinated delivery promise dates/times for the items 195, as well as associated costs. In various embodiments, at operation 330, multiple delivery promise dates and associated costs may be determined for multiple coordinated delivery options and may be based on information received from CDD 240, as described below. Particular examples of operation 330 are described below with reference to process 500 of FIG. 5. Next, at operation 340, the FD 250 may determine feasibility for potential coordinated delivery dates/times, such as based on the determination made by the DPD 230. As discussed herein, in various embodiments, feasibility may be determined based on multiple factors, including, but not limited to, shipping cost, price to customer, delivery time, item type, item weight, etc. Particular examples of operation 340 are described below with reference to process 600 of FIG. 6.

Next, at operation 350, the OP 260 may provide a CDO 125 based on the determined delivery promise date and the determined feasibility. In various embodiments, as discussed above, at operation 350 the OP 260 may provide a CDO that includes one or more of: a delivery promise date or dates, a shipping cost, a shipping option associated with the date, a shipper associated with the shipping option, etc. In various embodiments, the OP 260 may provide the CDO 125 through various techniques, including provision through an online or telephonic retail service, as may be understood.

Next, at operation 360, the CDDS 100 may receive a shipment order and begin delivery. At operation 370, the CDDS 100 may optionally adjust the delivery promise date during delivery. For example, if a shipped package is lost or delayed, or if an item out of the items 195 is lost or delayed during transfer to an FC 150, the CDDS 100, and in particular, the DPD 230 and/or FD 250, may determine a new delivery promise date or dates for the items 195, such as using the techniques described herein. In other embodiments, the CDDS 100 may adjust shipment options for one or more items 205 to cause delivery to be coordinated even when shipment of one or more items is delayed (or made earlier in time). Such delays may, in various embodiments, be based on item availability, FC 150 outages, transportation issues, or other problems. In various embodiments, if the cost, price, and/or delivery promise date changes substantially, the FD 250 may determine that coordinated delivery is no longer feasible and may determine that an adjusted delivery promise date may not be able to be provided. In such a case, the CDDS 100 may withdraw the previously provided CDO 125 and may offer to ship the items 195 in a non-coordinated fashion. The process may then end.

Referring now to FIG. 4 a flowchart illustrating an example process 400 for determining whether a user is likely to desire a coordinated delivery offer is illustrated in accordance with various embodiments. In various embodiments, process 400 may implement operation 320 of process 300 of FIG. 3. While particular examples and orders of operations are illustrated in FIG. 4, in various embodiments, these operations may be re-ordered, broken into additional operations, combined, and/or omitted altogether. In various embodiments, process 400 may be performed by the CDD 240 of the CDDS 100. It may be noted that particular examples are given of considerations and/or determinations that may be made by the CDD 240 in the course of performing process 400; however, in other embodiments, the CDD 240 may be configured to perform other determinations or considerations, or to omit one or more determinations or considerations illustrated in FIG. 4.

In various embodiments, the process of FIG. 4 may include determination by the CDD 240 of a coordinated offer desirability score (“CODS”), which may be compared to a threshold. In various embodiments, the CDD 240 may then cause a CDO 125 to be offered or not to be offered depending on whether the CODS meets the threshold. The process may begin at operation 410, where the CDD 240 may adjust the CODS based on whether the customer preferences of the customer 105 indicate that they desire to receive CDOs 125. In various embodiments, such customer preferences may be received from the customer information store 215. In various embodiments, customer preferences may include an explicit indication of desirability of CDOs 125, such as by including an explicit instruction that the customer 105 wishes to receive a CDO 125 when available; in such cases, the CODS may be increased. In other embodiments, the customer preference may be implicit, such as if the customer has previously been offered one or more CDOs 125 and has accepted one or more offers. In other embodiments, such as when the customer preferences indicate that no CDO 125 should be offered, or if the customer has previously elected to forego a CDO 125, then the CODS may be reduced.

Next, at operation 420, the CDD 240 may adjust the CODS based on whether associations between items indicate desirability of a CDO 125. In various embodiments, at operation 420, the CDD 240 may determine that items are likely to be intended to be utilized together. For example, the CDD 240 may identify that a request to purchase a media box and an HDMI cable at the same time means that the two items are to be used together. In another example, the CDD 240 may determine that an order for multiple books on the same topic may indicate that the books are to be read together. Other scenarios may be identified by the CDD 240. In other embodiments, if the items are of a very dissimilar type or value, such as an item of expensive jewelry and an inexpensive book, the CDD 240 may determine that is unlikely that a customer may desire to delay delivery of the jewelry to coordinate it with delivery of the book. If, at operation 420, the CDD 240 determines that item associations indicate desirability of receiving a CDO 125, then the CDD 240 may increase the CODS. If, however, the item associations indicate a CDO 240 may not be desired, the CODS may be decreased.

Next, at operation 430, the CDD 240 may adjust the CODS based on whether there is a possible event indicating desirability of a CDO 125. For example, in some scenarios, a customer may order multiple items that may be used to furnish a home, indicating that the customer may have recently moved (or be about to move) to a new home. In another example, the customer may order multiple items that may be used for a newborn baby. In another example, the customer may order multiple items that may be used for a party. Other scenarios may be identified by the CDD 240. If, at operation 430, the CDD 240 determines that there is a possible event indicating desirability of receiving a CDO 125, then the CDD 240 may increase the CODS.

Next, at operation 440, the CDD 240 may adjust the CODS based on whether multiple items being ordered require signatures or other special delivery (such as to a staff member or behind a secured door). Information used for such determinations may include specific customer instructions, customer order history, or item type or cost. If, at operation 440, the CDD 240 determines that required signatures or special delivery indicates desirability of receiving a CDO 125, then the CDD 240 may increase the CODS.

At decision operation 445, the CDD 240 may determine whether the CODS meets a threshold for offering a CDO 125. If so, then the process may proceed to operation 460, where the CDD 240 may determine that the customer is likely to desire a CDO 125 and may allow provisioning of a CDO 125 and the process may end. If however, the CODS does not meet the threshold, then at operation 450, the CDD 240 may determine that the customer is less likely to desire at CDO 125 and may not allow provisioning of a CDO 125. The process may then end.

Referring now to FIG. 5 a flowchart illustrating an example process 500 for determining one or more potential delivery promise dates/times is illustrated in accordance with various embodiments. In various embodiments, process 500 may implement operation 330 of process 300 of FIG. 3. While particular examples and orders of operations are illustrated in FIG. 5, in various embodiments, these operations may be re-ordered, broken into additional operations, combined, and/or omitted altogether. In various embodiments, process 500 may be performed to determine one or more delivery promise dates for coordinated delivery of the multiple items 195.

The process may begin at operation 510, where the DPD 230 may determine a delivery window within which to provide a coordinated delivery. In various embodiments, the DPD 230 may determine a delivery window based on one or more of pieces of information, some of which may be determined by the CDD 240 in the course of process 400. Such pieces of information may include, but are not limited to: customer preferences, item type, event determination, etc. In various embodiments, the determination of windows of various lengths may include a determination that items should be delivered simultaneously, over the course of one or more hours in a particular day, or over multiple days. Next, at optional operation 515, the DPD 230 may determine one or more potential order(s) for the requested items 205. As discussed above, in various embodiments, the DPD 230 may determine that it may be preferable to deliver one or more items prior to delivery of one or more other items. In various embodiments, the DPD 230 may make this determination based in part on information about the items 205, such as item type. In other embodiments, the DPD 230 may make this determination based on one or more determinations made when determining whether the customer is likely to desire a CDO 125.

Next, at operation 520, the DPD 230 may determine one or more FC locations for the items 195. In various embodiments, the DPD 230 may obtain FC information from the fulfillment information data store 220. Next, at operation 535, the DPD 230 may determine whether the items 195 are located in a single fulfillment center. If the items are located at a single FC 150, the process may proceed to operation 555, which is described below. If the items are not located at a single FC 150 the DPD 230 may determine whether items may be consolidated and shipped from one FC 150 (or, optionally, fewer FCs 150 than the items are currently located at). Thus, at optional operation 540, the DPD 230 may determine estimated trans-shipment times and/or costs to ship one or more of the items to a single FC 150. In various embodiments, these trans-shipment times and/or costs may be determined for one or more FCs 150 from which the items 195 may be later shipped for coordinated delivery. In other embodiments, CDOs 125 may be provisioned without checking for consolidation of items at a single shipment point. In such embodiments, operation 540 may be optional and trans-shipment times and/or costs may not be computed

The process may then proceed to operation 555. At loop operation 555, the DPD 230 may begin a loop over available combinations of shipping options and FCs 150. In various embodiments, different shipping options may be considered for different items, such as based on item type or location. For example, depending on item type, in the loop beginning at operation 555, the DPD 230 may consider air shipment, ground shipment, or other shipment. In some embodiments, shipping options may be limited based on item attributes, such as if an item must be shipped via ground shipping due to hazardous material restrictions, or should be shipped overnight (e.g., via air) due to perishability or urgency of need.

In this loop, at operation 560, the DPD 230 may determine whether the current combination of shipping options and FCs 150 may provide delivery of the items within the determined delivery window, e.g., based on information from the fulfillment information data store 220 and the outbound shipping capability data store 225. In various embodiments, the DPD 230 may determine whether the items can be delivered within the delivery window using techniques known to those of ordinary skill. In various embodiments, the combination of shipping options and FCs 150 considered at operation 560 may include shipment from a single FC 150, or from multiple FCs 150. In various embodiments, the combination may include trans-shipment of one or more items to consolidate items at one or more FCs 150 prior to shipping to the destination. In various embodiments, if the DPD 230 previously determined one or more potential delivery orders for items 205, then at operation 560, the DPD 230 may also determine whether this combination would satisfy one or more of the previously determined orders. In other embodiments, orders may not be considered, or may be ignored if no combination satisfies a determined order.

Next at operation 570, the DPD 230 may determine a delivery promise date for the current FC 150/shipping option. In various embodiments, at operation 570 the DPD 230 may determine estimated shipment time and/or cost for shipping the package(s). In various embodiments, this determined estimated shipment time and/or cost may be based, in part, on any estimated trans-shipment times and/or costs to ship items to the current single FC 150. For example, if trans-shipment times may cause items to be shipped together from an FC on a later date, delivery dates or times may be based on that later date, and may be different than estimated shipment times for items shipped on an earlier date. The delivery promise date may then be determined from the shipment time for the items. Next, at loop operations 585, the loop may continue for the next available combination of shipping option and FC 150. After the loop completes for all available combinations, the process may then end.

Referring now to FIG. 6 a flowchart illustrating an example process for determining feasibility of a delivery promise date is illustrated in accordance with various embodiments. In various embodiments, process 600 may implement operation 340 of process 300 of FIG. 3. While particular examples and orders of operations are illustrated in FIG. 6, in various embodiments, these operations may be re-ordered, broken into additional operations, combined, and/or omitted altogether. It may be noted that the process illustrated in FIG. 6 may be performed for a particular combination of shipping options and one or more FCs 150. Thus, in various embodiments, the process of FIG. 6 may be repeated for multiple combinations of shipping options and FCs 150.

The process may begin at operation 610, where the FD 250 may determine one or more non-coordinated packaging delivery dates, purchase prices, and/or costs for shipping the items 195. For example, the FD 250 may determine delivery dates, prices, and/or costs without attempting to coordinate delivery of the items 195. In various embodiments, these non-coordinated delivery dates and/or costs may be earlier dates and/or have lower costs than delivery dates or costs associated with coordinated-delivery options.

Next, at operation 620, the FD 250 may determine one or more thresholds for determination of feasibility. In various embodiments the FD 250 may determine time and/or cost thresholds based on the determined non-coordinated delivery dates and/or costs. These thresholds may be later compared to delivery promise dates or costs determined by the DPD 230. In various embodiments, these thresholds may be determined relative to the amount of shipping time or cost that may be experienced using non-coordinated delivery. For example, if a non-coordinated delivery option has a determined delivery date 3 days in the future, then a threshold of 4 days may be set so as not to allow provisioning of CDOs 125 that are, for example, 5 or 6 days in the future. However, if the non-coordinated delivery option has a determined delivery date 3 weeks (21 days) in the future, then a threshold may be set that allows provisioning of CDOs 125 that are, for example, up to 27 days in the future; this may be particularly true if the items are associated, such as a device and an accessory cable.

Similarly, cost thresholds may be set relative to the cost of non-coordinated delivery options. In various embodiments, these cost thresholds may be based, for example, on a particular ratio or percentage of the non-coordinated delivery cost. In other embodiments, the FD 250 may determine a price threshold for an amount that a total price for purchase of the items may rise in order to be offered to a customer. In various embodiments, any of the thresholds may be static and determined prior to the coordinated delivery offer provisioning techniques described herein. In other embodiments, such as those described above, any of the thresholds may be dynamic and based on the particular items, shipment times and/or costs. In other embodiments, other factors may be considered when determining thresholds, including, but not limited to: carrier capacity, time of day, time of year, shipping mode (e.g., ground vs. air), customer participation in a rewards program or delivery program, environmental impact of shipment option, etc. In yet other embodiments, customer preferences may be considered by the FD 250 when determining thresholds. For example, a customer may opt-in to receive CDOs 125, but may only wish to receive them when they add no more than a day to a delivery time, or no more than 10% to delivery cost, etc.

Next, at operation 630, each of the delivery promise date, price, and/or costs determined by the DPD 230 may be compared to the delivery and cost thresholds. At decision operation 635, the FD 250 may determine whether the various thresholds were met. If so, then at operation 640, the FD 250 may determine that the OP 260 may use the particular delivery promise date and cost for selection and provision of a CDO 125. If not, however, then at operation 650, the FD 250 may determine that the OP 260 may not use the particular delivery promise date and cost for selection and provision of a CDO 125. In either event, the process may then end.

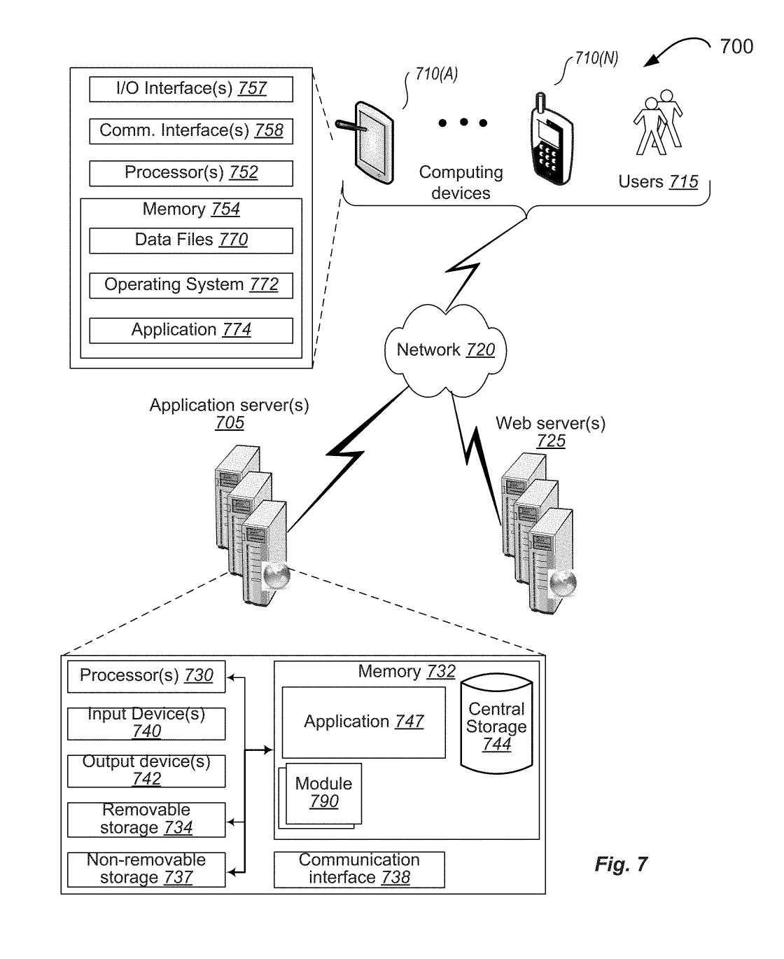

FIG. 7 illustrates an example of an illustrative computing environment 700 for implementing aspects in accordance with various embodiments described herein. The illustrative computing environment 700 may include one or more electronic computing devices 710(A)-710(N), which may include any appropriate device operable to send and receive requests, messages, or information over an appropriate network 720. Examples of such computing devices may include personal computers, smartphones, cell phones, handheld messaging devices, laptop computers, set-top boxes, personal data assistants, electronic book readers, tablet computers and the like.

The computing devices 710(A)-710(N) may include a processor 752 and memory 754 for storing processor-executable instructions, such as data files 770, operating system 772 and one or more applications 774. The operating system 772 may be a general purpose operating system such as a Microsoft Windows® operating system, a UNIX® operating system, a Linux® operating system or an operating system specifically written for and tailored to the computing devices 710(A)-710(N).

The computing devices 710(A)-710(N) may further include at least one or both of the following elements: input/output interface 757 and communication interface 758. The communication interface 758 may enable the computing devices 710(A)-710(N) to communicate data, control signals, data requests and other information with other resources including computers, data sources, storage devices and the like, over the appropriate computer network 720 such as the Internet, via wired or wireless connections. The input/output interface 757 may enable the computing devices 710(A)-710(N) to obtain data input from a variety of devices including, but not limited to, a digital pen, a touch screen, a keyboard, a mouse, a scanner and the like. In addition to the illustrative components described above, a display interface (not shown) may be used for outputting display information to a computer user 715. Typically, the display information may be outputted by the display interface via a display device (e.g., a CRT monitor, an LCD screen, a touch screen, a television, an integrated screen or sets of screens, etc.).

The network 720 may include any appropriate network, including an intranet, the Internet, a cellular network, a local area network, a personal network or any other such network or combination thereof. Components used for such a system can depend at least in part upon the type of network and/or environment selected. Protocols and components for communicating via such a network are well known and will not be discussed herein in detail. Communication over the network may be enabled by wired or wireless connections, and combinations thereof.

The memory 754 may generally comprise RAM, ROM and/or other permanent memory. Thus, in addition to storage in read/write memory (RAM), programming instructions may also be embodied in read-only format, such as those found in ROM or other permanent memory.

The illustrative computing environment 700 may include at least one application server 705 including, or associated with, one or more processors 730, input devices 740, output devices 742, removable storage 734 and non-removable storage 737 that may be connected to a communication interface 738 and memory 732. The memory 732 may include, but is not limited to, one or more applications 747.

The memory 732 may further include a centralized storage 744. As used herein, the centralized storage 744 may include any device or combination of devices capable of storing, accessing and retrieving data, which may include any combination and number of data servers, databases, data storage devices and data storage media, in any standard, distributed or clustered environment. It should be understood that there may be many other aspects that may need to be stored in the memory 732, which may be stored in any of the above-listed mechanisms as appropriate.

The memory 732 may further include, or be coupled with, one or more modules 790 which may correspond, for example, to the CDDS 100, the DPD 230, the CDD 240, the FD 250, or the OP 260, as described above.

The application server 705 may include any appropriate hardware and software for integrating with the centralized storage 744 as needed to execute aspects of one or more applications for the computing devices 710(A)-710(N), handling a majority of the data access and business logic for an application. The application server 705 may provide access control services in cooperation with the centralized storage 744, and is able to generate content such as text, graphics, audio and/or video to be transferred to a viewer, which may be served to the viewer by a Web server 725 in the form of HTML, XML or another appropriate structured language in this example. The handling of all requests and responses, (e.g., search requests and the results provided in response) as well as the delivery of content between the computing devices 710(A)-710(N) and the application server 705 may be handled by the Web server 725.

It should be understood that the Web and application servers 705 and 725 are not required and are merely example components, as the applications and software components discussed herein may be executed on any appropriate device or host machine, such as described elsewhere herein. Each server 705 or 725 may include an operating system that may provide executable program instructions for the general administration and operation of that server, and may include a computer-readable medium storing instructions that, when executed by a processor (e.g., 730) of the server, may allow the server to perform its intended functions. Suitable implementations for the operating system and general functionality of the servers are known or commercially available, and are readily implemented by persons having ordinary skill in the art, particularly in light of the disclosure herein.

The illustrative computing environment 700 may include a distributed computing environment utilizing several computer systems and components that may be interconnected via communication links, using one or more computer networks or direct connections. However, it will be appreciated by those of ordinary skill in the art that such a system could operate equally well in a system having fewer or a greater number of components than are illustrated in FIG. 7. Thus, the depiction of the illustrative computing environment 700 in FIG. 7 should be taken as being illustrative in nature, and not limited to the scope of the disclosure. In embodiments one or more of the computing devices 710(A)-710(N) may include or be directly coupled with a memory such as memory 732 that may include one or more modules 790 and/or the centralized storage 744.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, limited only by the claims.

1. A computer-implemented method for coordinating delivery of a plurality of items, the method comprising:
receiving, by a computing system, a request from a customer via a user interface rendered on a client device, the request being to purchase a plurality of items for shipment to a destination, wherein the plurality of items is deliverable to the destination at a plurality of original delivery promise dates;
determining, by the computing system, that the customer is likely to desire to receive a coordinated delivery offer to deliver the plurality of items at a same time based at least in part one at least one of: a customer purchase history, a customer request, or an item type;
communicating, by the computing system, with at least one database over a network to request and receive information maintained in the at least one database, the information including at least one of: fulfillment center information or item location information;
determining, by the computing system, a coordinated delivery promise date by which the plurality of items can be delivered to the destination at the same time, the coordinated delivery promise date being determined based at least in part on information received from the at least one database;
determining, by the computing system, a delivery time threshold based at least in part on one or more delivery times associated with the original delivery promise dates;
comparing, by the computing system, the coordinated delivery promise date to the delivery time threshold to determine that the coordinated delivery promise date is within the delivery time threshold; and
transmitting, via the computing system, the coordinated delivery offer to the client device associated with the customer in response to determining that the coordinated delivery promise date occurs within the delivery time threshold, the coordinating delivery offer including the coordinated delivery promise date.

2. The computer-implemented method of claim 1, wherein determining that the customer is likely to desire to receive a coordinated delivery offer comprises determining that one or more of the plurality of items are associated with each other.

3. The computer-implemented method of claim 1, wherein determining that the customer is likely to desire to receive a coordinated delivery offer comprises determining that one or more of the plurality of items requires a signature upon delivery.

4. The computer-implemented method of claim 1, further comprising determining, by the computing system, feasibility of delivering the plurality of items at the same time based at least in part on at least one of the item type or an item weight.

5. A computer-implemented method for facilitating coordinated shipment of items, the method comprising:
receiving, from a client device, by a computing system, an order to ship a plurality of items to a destination, the order being submitted via a user interface rendered on the client device;
communicating, by the computing system, with at least one database over a network to determine information associated with the plurality of items and a user associated with the client device, the information being maintained in the at least one database and including at least one of: an item type, fulfillment center information, oran item location information;
determining, by the computing system, one or more delivery promise dates in which at least a portion of the plurality of items can be delivered to the destination within a predetermined window of time, wherein the determining is based at least in part on the information; and
transmitting, to the client device, by the computing system, in response to the determination of the one or more delivery promise dates, a coordinated delivery offer to ship the at least a portion of the plurality of items such that the at least a portion of the plurality of items are expected to be delivered to the destination within the predetermined window of time.

6. The computer-implemented method of claim 5, wherein the destination comprises a single address.

7. The computer-implemented method of claim 5, wherein the destination comprises multiple addresses which are served by a common mail service.

8. The computer-implemented method of claim 5, further comprising determining that a customer associated with the client device is likely to desire to receive the coordinated delivery offer based at least in part on at least one of a customer request or an item type.

9. The computer-implemented method of claim 8, wherein determining that the customer associated with the client device is likely to desire to receive the coordinated delivery offer comprises determining that the at least a portion of the plurality of items are associated with each other.

10. The computer-implemented method of claim 8, wherein determining that the customer associated with the client device is likely to desire to receive the coordinated delivery offer comprises determining that the at least a portion of the plurality of items is associated with an event.

11. The computer-implemented method of claim 8, wherein determining that the customer associated with the client device is likely to desire to receive the coordinated delivery offer comprises determining that the at least a portion of the plurality of items requires a signature upon delivery.

12. The computer-implemented method of claim 5, wherein determining the one or more delivery promise dates comprises determining one or more dates by which the at least a portion of the plurality of items can be shipped to the destination from a single fulfillment center.

13. The computer-implemented method of claim 5, further comprising determining, by the computing system, feasibility of delivering the at least a portion of the plurality of items by the one or more delivery promise dates.

14. The computer-implemented method of claim 13, wherein determining feasibility comprises:
determining one or more cost estimates for delivery of the at least a portion of the plurality of items on the one or more delivery promise dates; and
comparing the one or more cost estimates for delivery to a cost threshold or a delivery threshold; and
wherein transmitting the coordinated delivery offer to the client device is based at least in part on a result of the comparing the one or more cost estimates to the cost threshold or the delivery threshold.

15. The computer-implemented method of claim 5, wherein receiving an order to ship a plurality of items comprises receiving a request from the client device to purchase the plurality of items.

16. The computer-implemented method of claim 5, wherein providing the coordinated delivery offer to ship the at least a portion of the plurality of items includes an offer to ship the at least a portion of the plurality of items such that they are to be delivered to the destination in a particular order.

17. One or more non-transitory computer-readable media containing instructions written thereon that, in response to execution on a computing system, cause the computing system to:
receive, from a client device associated with a customer, an order to ship a plurality of items to a destination;
determine that the customer is likely to desire to receive a coordinated delivery offer to deliver the plurality of items within a predetermined window of time based at least in part on at least one of: a customer purchase history, a customer request, or an item type;
communicate with at least one database over a network to request and receive information maintained in the at least one database, the information including at least one of: fulfillment center information, item location information, or customer preference information;
determine one or more delivery promise dates in which at least a portion of the plurality of items can be delivered to the destination within the predetermined window of time, wherein the determining is based at least in part on the information maintained in the at least one database; and
in response to the determination of the one or more delivery promise dates, transmit a coordinated delivery offer to the client device, the coordinated delivery offer being an offer to ship the at least a portion of the plurality of items such that the at least a portion of the plurality of items are expected to be delivered to the destination within the predetermined window of time.

18. (canceled)

19. The one or more non-transitory computer-readable media of claim 17, wherein determining that the customer is likely to desire to receive the coordinated delivery offer is further based at least in part on at least one of the at least a portion of the plurality of items being associated with an event or requiring a signature upon delivery.

20. The one or more non-transitory computer-readable media of claim 17, wherein determining the one or more delivery promise dates comprises determining one or more dates by which the at least a portion of the plurality of items can be shipped to the destination from a single fulfillment center.

21. The one or more non-transitory computer-readable media of claim 17, wherein the instructions further cause the computing system to at least determine feasibility of delivering the at least a portion of the plurality of items by the one or more delivery promise dates.

22. The computer-implemented method of claim 1, further comprising:
identifying a delay associated with at least one item of the plurality of items, the delay being associated with a fulfillment center outage, a transportation issue, or an item availability;
determining that a coordinated delivery is no longer feasible due to the delay; and
sending a request to the client device withdrawing the coordinated delivery offer.
